(19) United States
(12) Patent Application Publication
(10) Pub. No.: US 2005/0164786 A1
(43) Pub. Date: Jul. 28, 2005

(54) Gaming device having continuous rhythm reel sound

(75) Inventor: Michael P. Connelly, Elmwood Park, IL (US)

Correspondence Address: SCHWEGMAN, LUNDBERG, WOESSNER & KLUTH, P.A., P.O. BOX 2938, MINNEAPOLIS, MN, 55402-0938, US

(73) Assignee: WMS Gaming Inc.

(21) Appl. No.: 10/764,740

(22) Filed: Jan. 26, 2004

(51) Int. Cl. A63F 13/00

(52) U.S. Cl. 463/35; 463/20

(57) ABSTRACT

A computerized gaming system has an audio module that is operable to play an audio track during reel spins of a reel slot machine game, such that audio track rhythm is maintained over multiple reel spins. Rhythm is maintained such as by fading a looping audio track, or by tracking rhythm and restarting audio track play from a point calculated to maintain rhythm from a previous reel spin.

### FIELD OF THE INVENTION

The invention relates generally to gaming systems, and more specifically to computerized slot gaming systems having continuous reel sound.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computer elements have been employed in gaming systems, from computerized animation to playing prerecorded sounds through a gaming system's speakers. These are carefully designed, along with the general theme and other elements of a gaming system, to attract the attention of gamers and to provide a memorable gaming experience. But, because certain sounds associated with common actions repeat, some sounds can become repetitive. In video or mechanical reel slot systems in particular, rotating reels are typically accompanied by replayed music or rhythmic sounds. When a player plays the same reel slot game repeatedly, the sound repeats each time the reels spin, starting over for a few seconds and stopping again each time the reels spin. The sound can become not only repetitive, but can disrupt the flow of the game as it stops and restarts repeatedly.

It is therefore desired to employ a reel sound for slot systems presenting the game player with greater continuity in sound, to enhance flow and feel of game play.

### SUMMARY OF THE INVENTION

The present invention provides in one embodiment a computerized gaming system having an audio module that is operable to play an audio track during reel spins of a reel slot machine game, such that audio track rhythm is maintained over multiple reel spins. Rhythm is maintained in various embodiments such as by fading a looping audio track in and out or in and to a reduced volume, or by tracking rhythm and restarting audio track play from a point calculated to maintain rhythm from a previous reel spin.

### BRIEF DESCRIPTION OF THE FIGURES

FIG. 1 shows a computerized reel slot gaming system having an audio module consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized gaming system having an audio module that is operable to play an audio track during reel spins of a reel slot machine game, such that audio track rhythm is maintained over multiple reel spins. Rhythm is maintained in various embodiments such as by fading a looping audio track in and out or in and to a reduced volume, or by tracking rhythm and restarting audio track play from a point calculated to maintain rhythm from a previous reel spin. More detailed examples of the present invention are presented here to further illustrate how the present invention as claimed may be practiced in different embodiments.

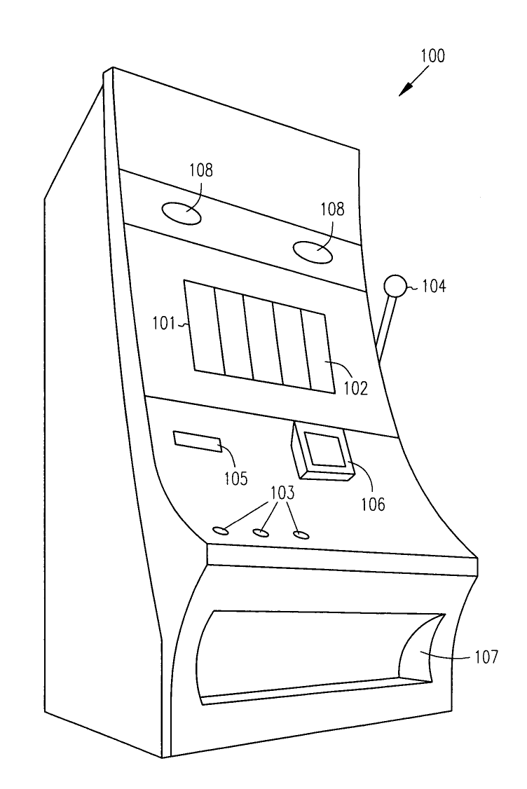

FIG. 1 illustrates a computerized reel slot machine gaming system having an audio module, consistent with an embodiment of the present invention. The computerized gaming system shown generally at 100 is a video gaming system, which displays information for at least one game of chance on video display 101. Alternate embodiments of the invention will have other game indicators, such as mechanical reels instead of the video graphics reels 102. The game of chance is played and controlled with various buttons 102, and in some embodiments also with a pull arm 104 to initiate reel spin. Value is wagered on the games, such as with tokens, coins, bills, or cards that hold value. The wagered value is conveyed to the machine through a changer 105 or a card reader 106, and winnings are returned via the returned value card or through the coin tray 107.

When the reels 102 are set to spin, a reel sound is typically played through speakers 108 to provide additional sensation of motion or action to the game player. When the reels stop spinning, the reel spin sounds are stopped. In typical systems, the played sound is restarted each time the reels are set spinning, resulting in a discontinuous audio presentation. The present invention seeks in some embodiments to provide a less disjointed game playing experience, by maintaining rhythm of the reel spin sounds across multiple spins of the reel.

In one example embodiment of the invention, the user begins playing the gaming machine 100 by depositing monetary value through coin, token, card, or other means, and pulls pull arm 104 to initiate reel spin. When the reels start spinning, an audio track having a discernible rhythm is played through speakers 108. In various embodiments of the invention, the reels may have independent sounds, or a single sound may be played indicating spinning for all reels. When the reels stop, the sound stops or is attenuated to a lower volume level. The gamer then looks at the results of the game played, accumulates winnings as paid out coins, credits, or through other means, and initiates another play by pulling lever arm 104 and spinning the reels again.

As the reels spin again, various embodiments of the invention will ensure that the rhythm of the previous spin is maintained, through various means such as by playing a continuous looping audio track that is faded in and out or by restarting the audio track at a point calculated to maintain rhythm with the audio presented during a preceding reel spin. A continuous audio track is used in some embodiments, and is played continuously between reel spins. In certain games, the gaming system will be in a “play” mode in which the reels can be spun, and the audio track will be played continuously during the play mode. When the audio track reaches its end, some embodiments of the invention will further loop the track back to the beginning and play it over again, synchronized in rhythm with the previous playing of the track so that rhythm is maintained.

The continuously played track is in some embodiments of the invention faded in or brought to a louder volume level when the reels are spinning, and is faded out either completely or brought to a reduced volume level when the reels are not spinning. Bringing the volume level to a reduced level instead of fading it out completely will in some gaming systems provide even greater continuity to the gaming experience, and may be particularly useful where the played audio is consistent with a particular theme of the game that is to be maintained and reinforced through sound during game play.

Playing the reel spin track continuously to maintain rhythm is further combined in some embodiments of the invention with additional effects, such as equalization, echo, reverb, distortion, flanging, or other such effects to differentiate between states in which the reels are spinning and states in which the reels are not spinning. Such embodiments can provide a basis for further coordination of game sounds, such as bangup sounds presented in conjunction with credits being awarded that are played in rhythm to the reel spin audio. Some embodiments of the invention will use multiple effects, in varying or random combinations, to provide a varying audio presentation to the gamer to prevent fatigue from repetition of the same sounds. Similarly, the reel spin tracks themselves in some embodiments comprise multiple tracks, from which only selected tracks are faded in and out on each reel spin. For example, a first spin may result in a base track and a trumpet track being faded in, while a subsequent spin may result in the base track plus a saxophone being faded in.

Alternate embodiments of the invention will not play a track continuously, but will maintain rhythm between two or more reel spins by synchronizing rhythm of reel spins sound with the rhythm of sound played during a preceding reel spin. This can be achieved through a variety of methods, including synchronizing all reel spin sounds with a rhythmic background track, or by using the computer's clock or other timing means to play reel spin sound from a point in the sound or at a time that preserves rhythm with preceding reel spin sounds.

These examples show some of the many ways in which a computerized gaming system can incorporate audio having a continuous rhythm from reel spin to reel spin, thereby creating a less disjointed game presentation to the game player. The examples here seek to ensure that rhythm is maintained between a reel spin associated sound and a preceding reel spin associated sound, creating a more continuous and attractive gaming experience. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized gaming system, comprising:
a gaming module, comprising a processor and gaming code which is operable when executed on the processor to conduct a reel slot machine wagering game on which monetary value can be wagered; and
an audio module, the audio module operable to play an audio track during reel spins, the audio module further operable to maintain audio track rhythm over multiple reel spins.

2. The computerized gaming system of claim 1, wherein the audio module is operable to maintain audio track rhythm over multiple reel spins by playing a track continuously and by further fading in the track in conjunction with a spinning reel and by fading out the track in conjunction with a stopped reel.

3. The computerized gaming system of claim 2, wherein the audio module is further operable to loop play the continuous track such that rhythm of the track is maintained.

4. The computerized gaming system of claim 1, wherein the audio module is operable to maintain audio track rhythm over multiple reel spins by playing the track from a point calculated to maintain rhythm from a previous reel spin upon initiation of reel spin.

5. The computerized gaming system of claim 1, wherein the reels are video representations of reels on a video slot machine.

6. The computerized gaming system of claim 1, wherein the reels are mechanical reels under the control of the computerized gaming system.

7. The computerized gaming system of claim 1, wherein the audio module is operable to maintain audio track rhythm over multiple reel spins by playing a track continuously and by further fading in the track in conjunction with a spinning reel and by fading the track to a reduced volume in conjunction with a stopped reel.

8. The computerized gaming system of claim 1, wherein the audio module is further operable to play at least one additional audio track in rhythm with the audio track played during reel spin.

9. A method of operating a computerized gaming system, comprising:
playing an audio track during reel spins of a reel slot machine game via an audio module, the audio module further operable to maintain audio track rhythm over multiple reel spins, and wherein the reel slot machine game comprises a game upon which monetary value can be wagered.

10. The method of claim 9, wherein the audio module is operable to maintain audio track rhythm over multiple reel spins by playing a track continuously and by further fading in the track in conjunction with a spinning reel and by fading out the track in conjunction with a stopped reel.

11. The method of claim 10, wherein the audio module is further operable to loop play the continuous track such that rhythm of the track is maintained.

12. The method of claim 9, wherein the audio module is operable to maintain audio track rhythm over multiple reel spins by playing the track from a point calculated to maintain rhythm from a previous reel spin upon initiation of reel spin.

13. The method of claim 9, wherein the reels are video representations of reels on a video slot machine.

14. The method of claim 9, wherein the reels are mechanical reels under the control of the computerized gaming system.

15. The method of claim 9, wherein the audio module is operable to maintain audio track rhythm over multiple reel spins by playing a track continuously and by further fading in the track in conjunction with a spinning reel and by fading the track to a reduced volume in conjunction with a stopped reel.

16. The method of claim 9, wherein the audio module is further operable to play at least one additional audio track in rhythm with the audio track played during reel spin.

17. A computerized gaming system, comprising:
a gaming module, comprising a processor and gaming code which is operable when executed on the processor to conduct a reel slot machine wagering game on which monetary value can be wagered; and
an audio module, the audio module operable to play an audio track during reel spins at a louder volume level and to play the audio track at a quieter or muted volume level when the reels are not spinning, the audio module further operable to maintain audio track rhythm over multiple reel spins.

18. The computerized gaming system of claim 12, wherein the audio track comprises multiple audio element tracks, and wherein only select audio element tracks are played on each reel spin.

19. The computerized gaming system of claim 18, wherein at least one of the selected audio element tracks played on each reel spin is randomly selected for each reel spin.

20. A machine-readable medium with instructions stored thereon, the instructions when executed operable to cause a computerized gaming system to:
conduct a reel slot machine wagering game upon which monetary value can be wagered; and
play an audio track during reel spins at a louder volume level and to play the audio track at a quieter or a muted volume level when the reels are not spinning, the audio module further operable to maintain audio track rhythm over multiple reel spins.
